(19) United States
(12) Patent Application Publication
(10) Pub. No.: US 2019/0113220 A1
(43) Pub. Date: Apr. 18, 2019

(54) Speaker Light Fixture

(71) Applicants: Edward Haase, Henderson, NV (US); Richard Blair Millson, Vancouver (CA); Alan Toyonobu Ima, Vancouver (CA); Adam Stefanski, Vancouver (CA)

(72) Inventors: Edward Haase, Henderson, NV (US); Richard Blair Millson, Vancouver (CA); Alan Toyonobu Ima, Vancouver (CA); Adam Stefanski, Vancouver (CA)

(21) Appl. No.: 16/146,763

(22) Filed: Sep. 28, 2018

Related U.S. Application Data
(60) Provisional application No. 62/572,640, filed on Oct. 16, 2017.

(51) Int. Cl. F21V 33/00; F21V 29/74; F21V 7/04; H04R 1/02; H04R 1/24; H04R 1/04

(52) U.S. Cl. CPC F21V 33/0056; F21V 29/74; F21V 7/041; F21Y 2115/10; H04R 1/24; H04R 1/04; H04R 1/028

(57) ABSTRACT

Improvements in a light with a speaker for home or business installation. The lighting fixture houses the audio receiver/audio amplifier for the speaker, the lighting element and control driver for the lighting element. Keeping all of these elements in the same fixture creates a single package for installation. The light emitting diode (LED) has a heatsink that conducts heat from the LED to an area at the top of the fixture. Diverting the heat away from the LED moves the heat away from the speakers and also opens the lower area of the fixture for better acoustics. The heatsink passes through a large diameter woofer that moves air for cooling of the heatsink and the LED lighting. The audio receiver/audio amplifier for the speaker can obtain an audio signal from a wired or wireless connection. A microphone can also be included for two-way communication.

### CROSS REFERENCE TO RELATED APPLICATIONS

This application claims the benefit of Provisional Application Ser. No. 62/572,640 filed Oct. 16, 2017 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in a lighting fixture with an integrated speaker. More particularly, the present invention relates to a ceiling or wall mount fixture that combines both lighting and sound in a single fixture. The fixture is designed with LED lighting and includes a heatsink to conduct heat from the illumination element to an area on the top area of the fixture. Signal to the speaker is with a wired or wireless connection. An additional benefit of the invention is that the LED lighting portion and the Speaker portion are able to be installed and activated separately and independently from one another, allowing an LED lighting fixture to be upgraded at any time with the addition of the speaker component.

### Description of Related Art Including Information Disclosed Under 37 CFR 1.97 and 1.98

Most buildings constructed today include one or more can style lighting fixtures where the lighting fixture is recessed into a wall or ceiling. Many buildings also include an intercom or speakers that are also mounted in the wall or ceiling. The installation of the lighting and sound are usually provided by different tradesman during the construction of the buildings. Some patents have been issued on products to try to combine the lighting and sound as a single element.

LED's are now commonly used for illumination because they are easy to configure for different lighting applications. One common problem with LED lights is the heat that is locally generated near the light emitting element.

U.S. Pat. No. 1,272,843 issued to H. G. Pape on Jul. 6, 1918, U.S. Pat. No. 4,433,363 issued on Feb. 21, 1984 and U.S. Pat. No. 4,528,620 issued on Jul. 9, 1985 both issued to Weber, reference a sound lighting fixture that is suspended free ceiling. All three of these issued patents disclose a sound producing element combined with incandescent lighting. None of these three patents disclose that the lighting and sound fixture is for recessed ceiling or walled installation or for mounting on a wall or ceiling nor do they disclose using low voltage lighting, a wireless receiver or digital signal processing to account for placement or fixture construction. The orientation of the sound producing elements is also not adjustable to direct sound waves to a particular location.

U.S. Pat. No. 4,776,018 issued to Cordier on Oct. 4, 1988 and U.S. Pat. No. 5,980,057 issued to Cristie on Nov. 9, 1999 both disclose screw-in combination lighting/sound fixtures. Both of these two patents are for a standalone screw in lighting fixture that can be installed inside an existing lights socket and include a wireless receiver for receiving audio signal. Neither of these two patents provide a recessed lighting fixture they're simply lighting elements for installation in an existing fixture and do not include digital signal processing to account for placement or fixture construction. The sound producing elements are not oriented to direct sound waves to a particular unidirectional location.

U.S. Pat. No. 2,083,753 issue to A. R. Turner on Jun. 15, 1937 and U.S. Pat. No. 4,953,584 issued to Kawahata et al. on Dec. 17, 1985 both disclose lighting fixtures for mounting on the ceiling. In the case of Turner, a portion of the fixture is extensible below the ceiling and above the ceiling. In the case of Kawahata et al. the fixture is mounted in the ceiling. Neither of these two patents discloses using low voltage lighting within the fixture. The orientation of the sound producing element is fixed within the fixture and cannot be oriented to direct sound ways to particular location.

U.S. Pat. No. 7,455,435 Issued Nov. 25, 2008 to David K. Mathews et al., discloses a High-Speed Data Interface to the AC Power Line through a Standard Light Bulb Socket. In this application, a speaker is threaded into a light socket and the light bulb is then screwed into the speaker. This is not a single integrated speaker and light, nor does it provide omni-directional light.

What is needed is a speaker light fixture that integrates a light and a speaker into the same recessed lighting fixture. The illumination is provided from efficient LED elements and sound is provided from separate but integrated speaker components. The proposed application provides these features, with the speaker portion being easily added at any time and functions in a complete package that can be installed as a can light fixture and heat from the LEDs are conducted away from the light source.

### BRIEF SUMMARY OF THE INVENTION

It is an object of the speaker light fixture to provide a lighting element that is configured to operate in a can lighting fixture. The can lighting fixture houses both the speaker and the audio receiver/amplifier for the speaker, as well as the lighting element and the control driver for the lighting element. Keeping all of these elements in the same fixture creates a single package for installation. The housing is installed with the initial installation onto the studs or joists of new construction or remodeling, and the speaker and the audio receiver/audio amplifier for the speaker, as well as the lighting element and the control driver for the lighting element can be installed at a later time.

It is another object of the speaker light fixture for the lighting element to be a light emitting diode (LED) and for the LED to be connected to a heatsink that diverts heat from the LED to an area at the top of the fixture. Diverting the heat away from the LED moves the heat away from the speakers and also opens the lower area of the fixture for better acoustics.

It is another object of the speaker light fixture for the heatsink for the lighting element to transfer heat through the center of a speaker. In general, the speaker would be a large diameter woofer where the woofer moves a larger volume of air and the open center of the woofer allows free movement of the woofer and this movement of the woofer furthers air movement for cooling of the heatsink and the LED lighting.

It is still another object of the speaker light fixture that the signal to the sound producing elements be provided as a wired connection or as a wireless connection. The wireless connection may also include a repeater that can increase the distance that the wireless signal may be sent and/or received.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of the speaker light fixture.

FIG. 2 shows a perspective view of the mounting box as viewed from below.

FIG. 3 shows a perspective view of the mounting box as viewed from above with the top pf the enclosure removed for visibility of the internal components.

FIG. 4 shows an exploded perspective view of the speaker light fixture.

FIG. 5 shows an exploded perspective view of the lighting elements.

FIG. 6 shows an exploded perspective view of the speaker light fixture.

FIG. 7 is a cross-sectional view of the speaker light fixture.

FIG. 8 is a perspective room view of the speaker light fixture viewed from below without a cosmetic covering.

FIG. 9 is a perspective view of the cosmetic grill covering.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

### ITEM NUMBERS AND DESCRIPTION

19 speaker light fixture
21 outer ring
22 speaker/tweeter
23 woofer frame
24 surround
26 woofer cone
27 microphone
31 threads
32 top cap/heat sink
33 spacer/cushion
34 spacer/cushion
35 woofer speaker enclosure
36 cosmetic grill cover
40 cylindrical body
41 reflector cone
42 light (LED)
43 heat sink transfer shaft
44 threaded end
45 flare
46 ribs
48 magnetic fastener
49 woofer magnet
50 woofer
51 clearance hole
70 lens
71 lens spacer ring
72 cosmetic facia round
73 cosmetic facia square
80 studs or joists
81 span bracket
82 span bracket
83 rear opening
84 side wall
86 opening
87 electrical power knock-out
90 LED driver module
91 electrical power junction box
92 audio streamer/amplifier/wireless transceiver unit
93 antenna
94 drywall
95 mounting box front face
96 mounting box

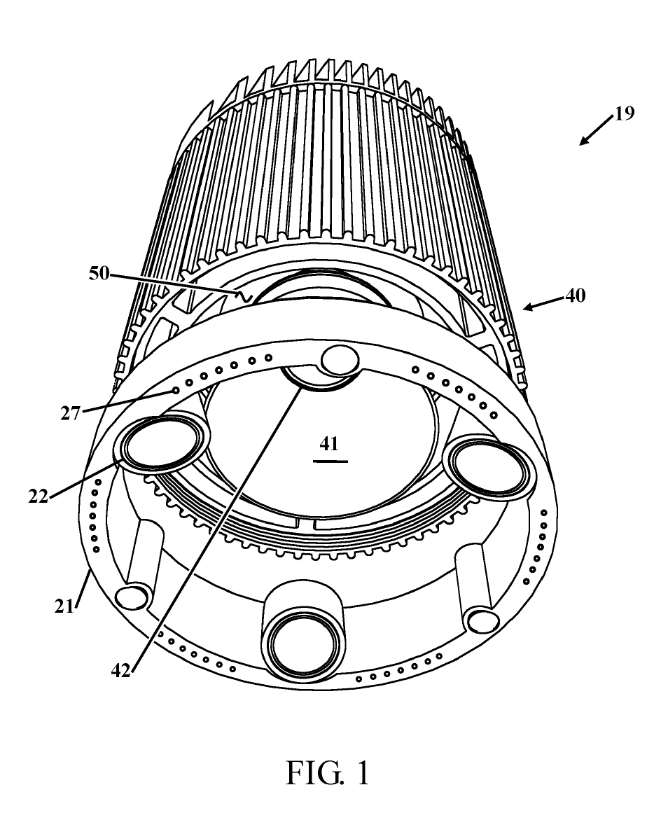

FIG. 1 shows a perspective view of the speaker light fixture 19. The speaker light fixture is configured in a cylindrical shape to fit within a custom recessed can lighting fixture. The speaker and lighting elements project downward and outward from the underside of the cylindrical shape of the speaker light fixture 19. Because the Light Emitting Diodes (LED) generate heat, the heat must be removed from near the LED elements 42 to reduce heat damage to the speaker elements and extend the life of the LED elements 42. Moving heat away from the speaker elements further extends the life of the speakers.

Due to the limited space within the fixture and the inclusion of multiple speaker elements, the heat is transferred through the body of the speaker light fixture 19 to external cooling fins in the cylindrical body 40 and the top cap/heatsink 32. The LED 42 is one or more clusters of LEDs 42. A reflector or diffuser cone 41 focuses or directs the light from the LED's 42. The heatsink from the LED's is passed through a low frequency speaker, such as a woofer or mid-range speaker 50.

One or a plurality of higher frequency speakers 22 or mid-tweeters are arranged in the front of outer ring 21. While this configuration shows three mid/high frequency speakers 22, more than three or less than three speakers 22 are contemplated based upon the desired sound quality or high frequency dispersion pattern. The overall length and diameter of the speaker light fixture 19 is determined by the desired diameter of the fixture and the wall stud or joist spacing and depth. One or more microphones 27 can be included in the outer speaker ring 21. While the microphones 27 are shown in the outer speaker ring 21 they can be located in other locations or can be on a separate ring.

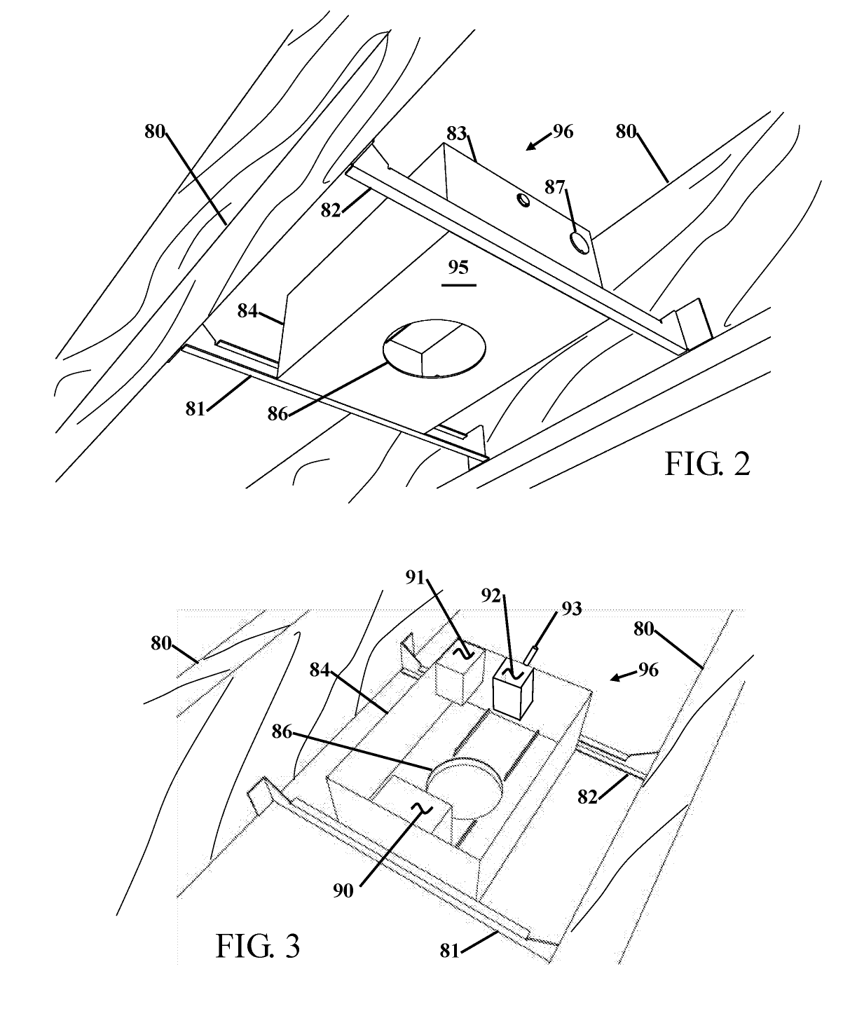

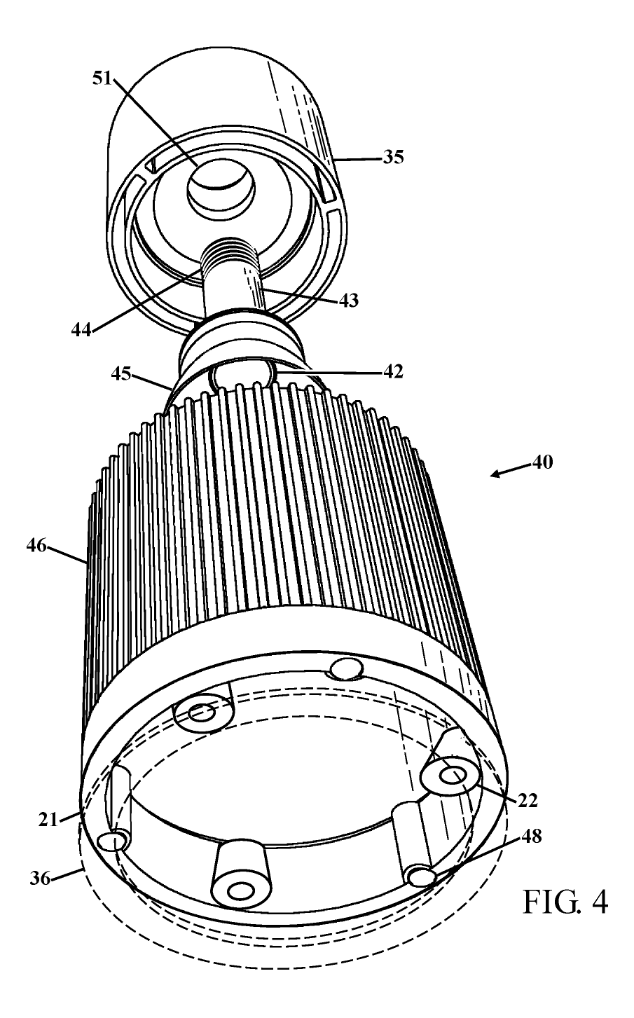

FIG. 2 shows a perspective view of the mounting box as viewed from the ground and FIG. 3 shows a perspective view of the mounting box as viewed from above with the top removed to provide visibility of the internal components. The mounting box is installed in new or remodeling construction between studs or joists 80. Span brackets 81 and 82 connect between the joists 80 to support the mounting box. While a standard mounting box may be used, in this embodiment the mounting box houses internal connection features and junctions that are shown in FIG. 3.

In FIG. 3 the internal connections are for the external power connection box 91 that enters through electrical knock-out 87. This provides both the power to the LED's and to a receiver and or amplifier in the audio streamer/amplifier/wireless transceiver unit 92. A power converter can also be included in the junction box to convert current and voltage to drive the LED's. The electrical junction box provides termination and cross connection of electrical power. This eliminates an additional source for heat generation within the speaker light fixture. A wireless receiver in the audio streamer/amplifier/wireless transceiver unit 92 can be included with an antenna 93 that can pass outside of the mounting box. The LED driver module 90 is shown within the mounting box 96.

The mounting box is preferably formed from sheet metal with side walls 84, a mounting box front face 95 with an opening 86 for the light speaker and a rear opening 83 that is optionally covered with a back plate (not shown in these figures). The mounting box is a self-contained enclosure that provides the electrical and audio connections, mounting for the speaker light fixture as well as protects the components.

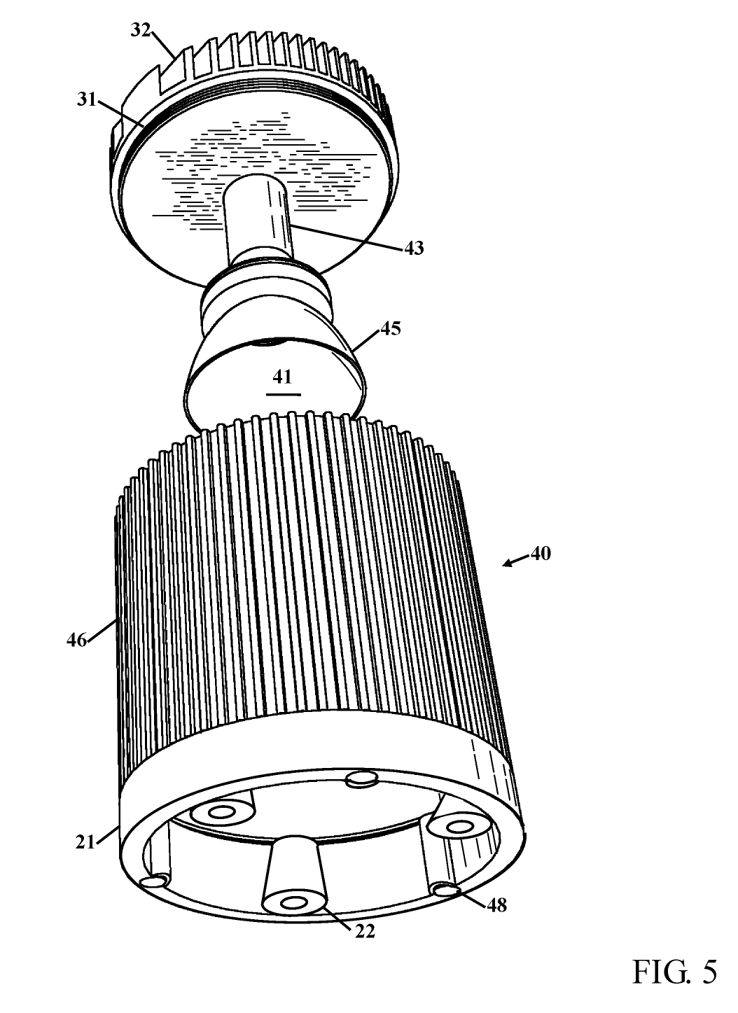

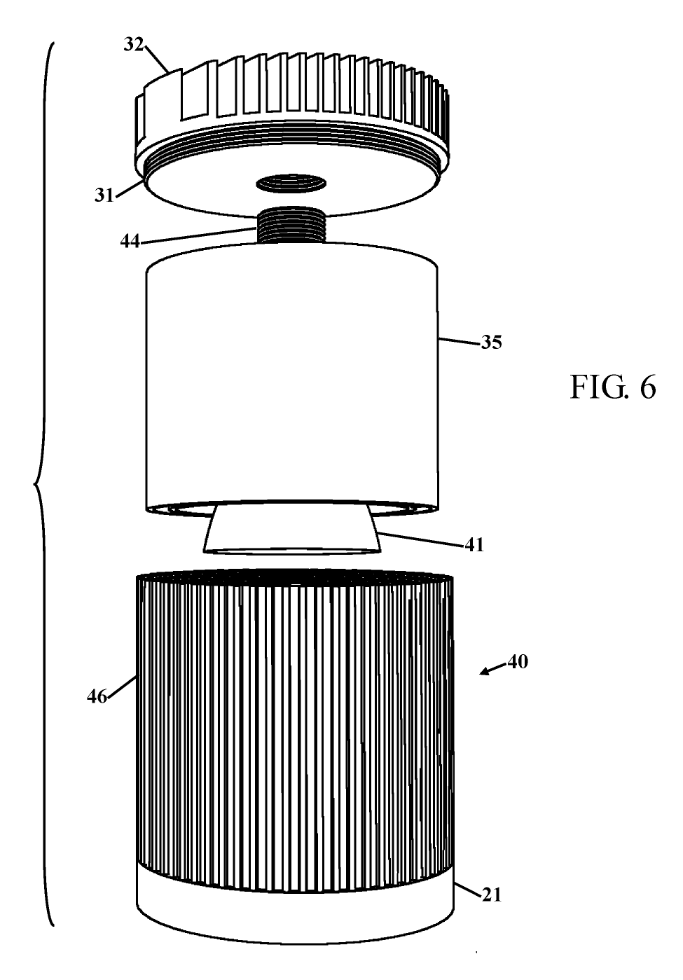

FIG. 4-FIG. 6 show exploded perspective views of the different lighting elements and speaker elements. In these figures some elements have been removed for clarity. In FIG. 4, woofer speaker enclosure 35 is shown with the clearance hole 51 through the center of the woofer speaker. The clearance hole 51 provides an opening for the heatsink transfer shaft 43 to pass through. The rear portion of the heatsink transfer shaft has threads 44 that thread into and affix the top cap/heatsink 32 but other securing mechanisms are contemplated.

The top cap/heatsink 32 has a plurality of cooling fins that absorb and disperse heat that is transferred through the heatsink transfer shaft 43. The outer surface of the top cap/heatsink 32 includes threads 31 to connect the top cap/heatsink 32 to the cylindrical body 40. The cylindrical body 40 that also has integral ribs 46 or fins to provide additional surface area for cooling. The outer (lower) surface of the cylindrical body 40 has an outer speaker ring 21 with one or more magnet fasteners 48 for securing a cosmetic grill covering 36 over the front of the speaker light fixture to provide a cosmetic covering that allows both light and sound to transfer through the cosmetic grill covering 36.

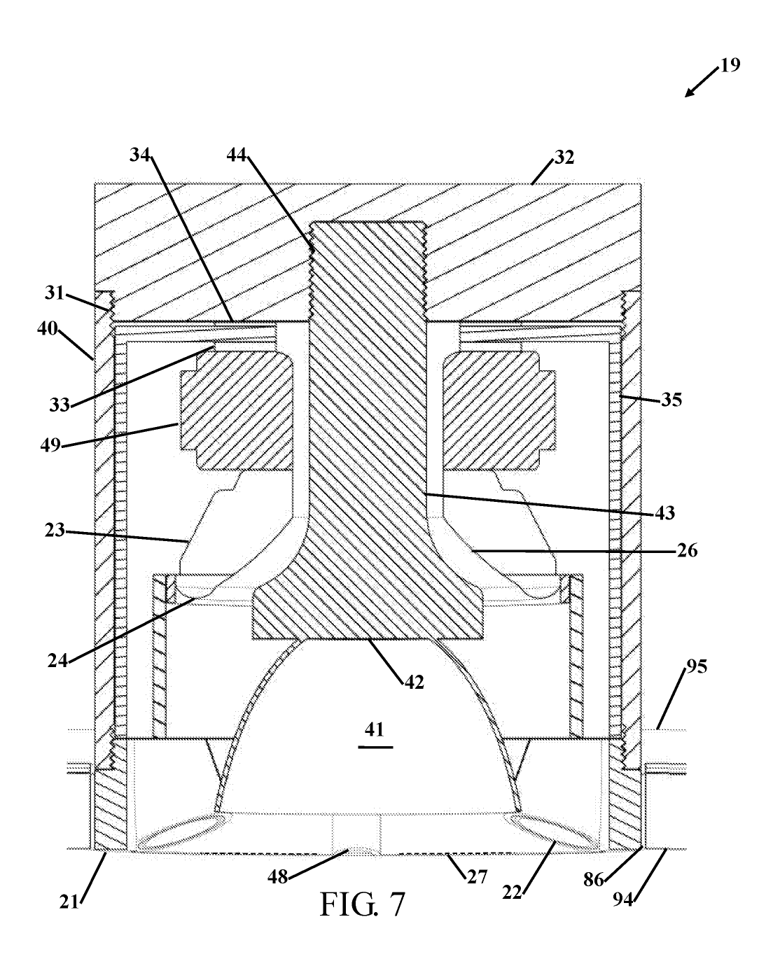

Referring back to the heatsink transfer shaft 43, the heatsink transfer shaft 43 passes through clearance hole 51 the speaker voice coil and the woofer. The heatsink transfer shaft 43 connects to the LED element(s) 42 to transfer heat away from the LED's 42. A reflector cone 41 focusses or directs the light from the LED's 42. The inside of the reflector cone 41 is coated and shaped to provide the desired light handling. The reflector cone 41 is flared 45 to further spread and focus the light. To prove a description of all the assembled components a cross-section view is provided in FIG. 7.

FIG. 7 is a cross-sectional view of the speaker light fixture 19. In this figure the speaker light fixture 19 is shown installed in a ceiling with the outer speaker ring 21 in a clearance hole 86 surrounded by drywall 94 or sheet rock. A portion of the mounting box front face 95 is shown covered with the drywall 94. This is generally the orientation and configuration for how the speaker light fixture 19 would be installed. It is possible to install the speaker light fixture 19 in a horizontal configuration. The speaker light fixture 19 is essentially a cylindrical body that threads together axially but other securing mechanisms are also contemplated.

The LED's 42 are in the center of the speaker light fixture 19 within a reflector cone 41. The size and shape of the reflector cone 41 is determined by the emitting angle of the LED's 42 and the desired light dispersion from the speaker light fixture 19. The rear of the LED's 42 is connected to the heatsink transfer shaft 43. The heatsink transfer shaft 43 passes concentrically through the clearance hole 51 and the magnet 49 of the woofer 50. While the heat transfer shaft is shown as a solid shaft, the heat transfer shaft can be hollow or ribbed. The heat transfer shaft 43 is shown threaded into the top cap heatsink 32. The outer lower edge of the top cap heatsink 32 has threads 31 that thread into the cylindrical body 40. The cylindrical body 40 is threaded at both ends, and at the lower end the cylindrical body 40 is threaded into the outer speaker ring 21. A spacer cushion 34 accommodates variation in manufacturing dimensions and provides an air tight seal between the cap heatsink 32 and the woofer speaker enclosure 35. The assembled components sandwich the woofer speaker enclosure 35 within the speaker light fixture 19.

The cross-section FIG. 7 shows the magnet 49 within the woofer speaker 50. The magnet and voice coil move the woofer cone 26 that is supported on the woofer frame 23 by the circular surround suspension 24. A spacer cushion 33 pads the rear of the woofer magnet 49. The woofer 50 is further suspended within the woofer speaker enclosure 35.

The outer speaker ring 21 has features that support one or a plurality of high frequency mid-tweeter speakers 22. The mid-tweeters may be angled to project the higher frequency sound within the room. The outer speaker ring 21 further has features, such as magnets 48 or other fasteners to attract or secure a cosmetic facia 36. The outer speaker ring 21 also has one or more microphone elements 27 to receive spoken word or other audio sounds or test signals from within the room in which the speaker light fixture 19 is located.

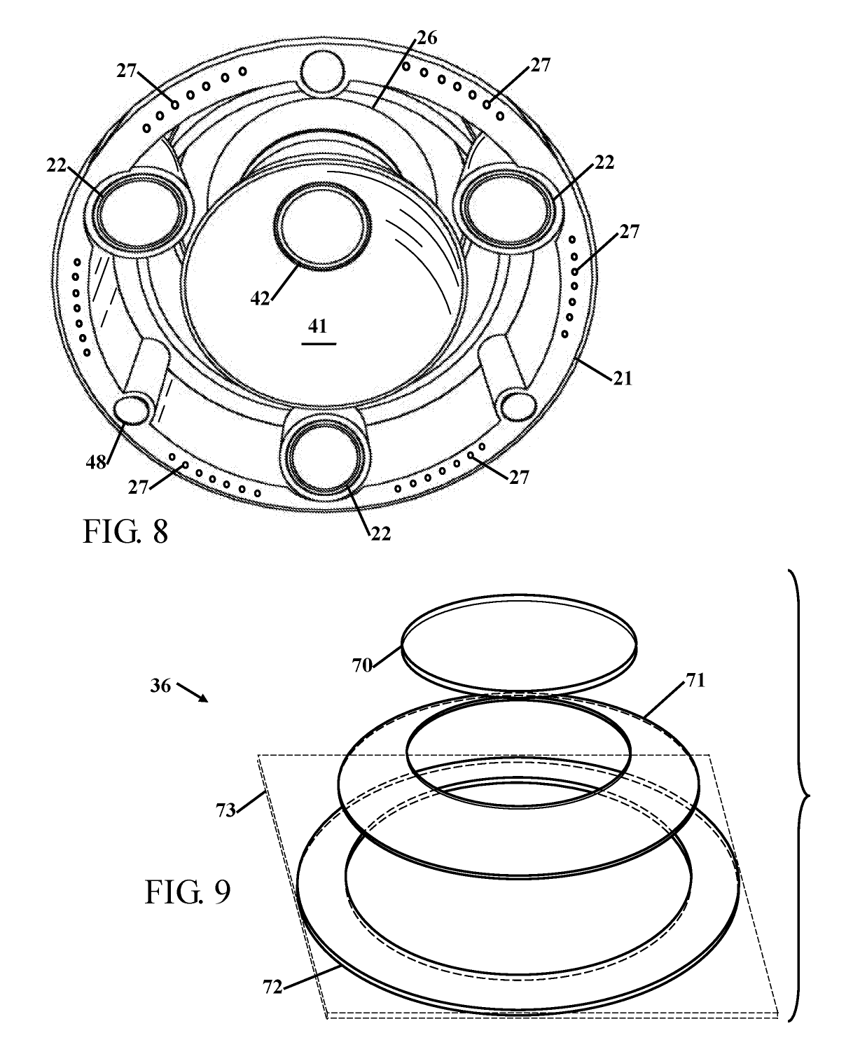

FIG. 8 is a perspective room view of the speaker light fixture 19 without cosmetic facia 36 installed. The outer speaker ring 21 is shown with three mid-high frequency speakers 22. Because higher frequency speakers are more unidirectional, more than one high frequency speaker is used. There is a plurality of openings for microphones 27 to allow one or a group of people to be heard using the speaker light fixture 19. The LED 42 is shown in the center of the reflector cone 41. The reflector cone 41 directs the light outside of the speaker light fixture. A portion of the lower frequency woofer cone 26 is shown behind and around the reflecting cone 41. Because lower frequency sounds are more omni-directional, the sounds from the woofer cone 26 can pass around the reflector cone 41 and spread within a room. The outer speaker ring 21 is shown with magnetic fasteners 48 that provide attraction to a cosmetic outer covering that is shown and described in more detail in other figures and description herein.

FIG. 9 is a perspective view of the cosmetic facia 36. In this figure, a glass or plastic lens 70 covers the LED 42. A sound transmissive lens spacer ring 71 allows sound to pass out of the speaker light fixture 19, and a cosmetic facia 72 surrounds the lens spacer ring 71. The shape of the cosmetic facia 72 is shown as round, in solid line and square 73 in broken line. While these two shapes are shown other shapes are contemplated based upon the desired appearance. It is contemplated that the cosmetic facia 72 is fabricated from a ferric material to allow the cosmetic facia covering to be secured to the speaker light fixture 19 with magnetic fasteners 48 for easy installation and removal, but other securing mechanisms are contemplated.

Thus, specific embodiments of a speaker light fixture have been disclosed. It should be apparent, however, to those skilled in the art that many more modifications besides those described are possible without departing from the inventive concepts herein. The inventive subject matter, therefore, is not to be restricted except in the spirit of the appended claims.

1. A speaker light fixture comprising:
a light emitting diode illumination source on a first side of a speaker;
said light emitting diode illumination source is thermally connected to a heatsink transfer shaft;
said heatsink transfer shaft passes through a speaker cone voice coil and a magnet of said speaker;
said heatsink transfer shaft is thermally connected to a heatsink cap at a second side of said speaker, and
said light emitting diode illumination source and said speaker are oriented to emit light and sound respectively from said first side of said speaker.

2. The speaker light fixture according to claim 1, wherein said speaker is a midrange or a woofer.

3. The speaker light fixture according to claim 2, wherein said heat sink transfer shaft extends concentrically through said magnet structure of said midrange or said woofer.

4. The speaker light fixture according to claim 3, wherein said midrange or said woofer is configured to increase airflow past said heat sink transfer shaft.

5. The speaker light fixture according to claim 1, that further includes at least one mid-high frequency speaker arranged in front of or co-planar with said light emitting diode illumination source.

6. The speaker light fixture according to claim 5, wherein at least one said mid-high frequency speaker is located outside of a reflective cone.

7. The speaker light fixture according to claim 1, that further includes at least one microphone.

8. The speaker light fixture according to claim 1, wherein at least one said microphone is located in an outer ring.

9. The speaker light fixture according to claim 1, wherein said heatsink cap is thermally connected to an outer frame body.

10. The speaker light fixture according to claim 9, wherein said outer frame body is cylindrical and is threaded onto said heatsink cap.

11. The speaker light fixture according to claim 9, wherein said outer fame body connects to an outer ring.

12. The speaker light fixture according to claim 11, wherein said outer ring includes a plurality of magnets.

13. The speaker light fixture according to claim 13, wherein said magnets are configured to retain a cosmetic facia or grill.

14. The speaker light fixture according to claim 1, wherein said light emitting diode source is located within a reflective cone.

15. The speaker light fixture according to claim 11, further includes a speaker enclosure that is located between said heatsink cap and said outer ring.

16. The speaker light fixture according to claim 1, wherein said speaker light fixture further includes a mounting box.

17. The speaker light fixture according to claim 16, wherein said mounting box is configured to mount onto studs or joists.

18. The speaker light fixture according to claim 16, wherein said mounting box includes an electrical junction box for termination and cross connection of electrical power.

19. The speaker light fixture according to claim 16, wherein said mounting box includes a power converter or control driver for said light emitting diode illumination source.

20. The speaker light fixture according to claim 16, wherein said mounting box includes an audio streamer/amplifier/wireless transceiver unit that is configured to receive audio and control signals by a wired or wireless connection.

21. The speaker light fixture according to claim 20, wherein said audio streamer/amplifier/wireless transceiver unit controls signals to said speakers.
